(19) United States
(12) Patent Application Publication
(10) Pub. No.: US 2026/0131555 A1
(43) Pub. Date: May 14, 2026

(54) TEXTILE FABRIC

(71) Applicant: JHIH HUEI TRADING CO., LTD., CHANGHUA COUNTY (TW)

(72) Inventor: YUNG-YU WU, Changhua County (TW)

(21) Appl. No.: 18/944,035

(22) Filed: Nov. 12, 2024

(51) Int. Cl. B32B 5/02; B32B 3/26; B32B 3/30; B32B 7/04

(52) U.S. Cl. CPC B32B 5/024; B32B 3/266; B32B 3/30; B32B 7/04; B32B 2262/0207; B32B 2262/0292; B32B 2307/51; B32B 2437/00

(57) ABSTRACT

The present invention provides a textile fabric, including a main body, a first covering layer and a second covering layer. The main body is made of a plurality of yarns interlaced with one another and includes two surfaces opposite to each other and a plurality of through holes extending through the two surfaces. The plurality of yarns include at least one elastic yarn. The first covering layer is coveringly disposed on one of the two surfaces and includes at least one first region and at least one second region, and a thickness of each said second region is different from a thickness of one said first region. The second covering layer is coveringly disposed on the other of the two surfaces and connected with the first covering layer via the plurality of through holes.

### BACKGROUND OF THE INVENTION

### Field of the Invention

The present invention relates to a textile fabric.

### Description of the Prior Art

Textile fabrics are made of a plurality of yarns by different techniques such as knitting and weaving, and they are widely used in daily life including clothing, shoes, bags, etc. Specifically, the plurality of yarns may be selected from elastic yarns so that the textile fabrics are elastically stretchable and applicable to abdominal binders, braces, shoes, or other objects.

However, an existing elastic textile fabric is easy to be worn and fall apart, and the existing elastic textile fabric has to be combined with other materials (such as a non-elastic fabric) in order to be connected with accessories such as fasteners, zippers, shoelace eyelets, etc., which is inconvenient to manufacture and restricts product design. In addition, a tensile strength of the existing elastic textile fabric is improved by increasing a weaving density or a number of layers, changing a number or material of elastic yarns, etc., which is inconvenient to manufacture and high cost, and the existing elastic textile fabric still provides poor wear-resistant effect.

The present invention is, therefore, arisen to obviate or at least mitigate the above-mentioned disadvantages.

### SUMMARY OF THE INVENTION

The main object of the present invention is to provide a textile fabric, which is elastically stretchable and easy to be processed to locally increase tensile strength.

To achieve the above and other objects, the present invention provides a textile fabric, including a main body, a first covering layer and a second covering layer. The main body is made of a plurality of yarns interlaced with one another and includes two surfaces opposite to each other and a plurality of through holes extending through the two surfaces. The plurality of yarns include at least one elastic yarn. The first covering layer is coveringly disposed on one of the two surfaces and includes at least one first region and at least one second region, and a thickness of each said second region is different from a thickness of one said first region. The second covering layer is coveringly disposed on the other of the two surfaces and connected with the first covering layer via the plurality of through holes.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a side view of a preferable embodiment of the present invention;

FIG. 2 is a partial cross-sectional view of FIG. 1; and

FIG. 3 is a partial cross-sectional view of another preferable embodiment of the present invention.

### DETAILED DESCRIPTION OF THE PREFERRED EMBODIMENTS

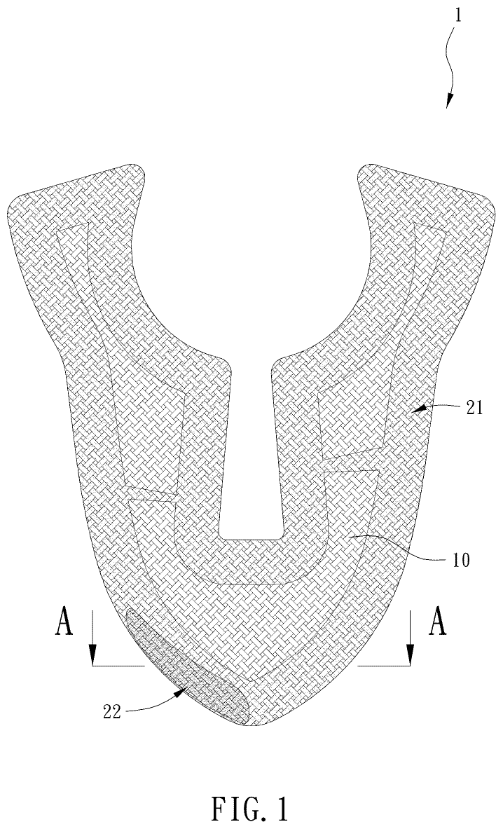

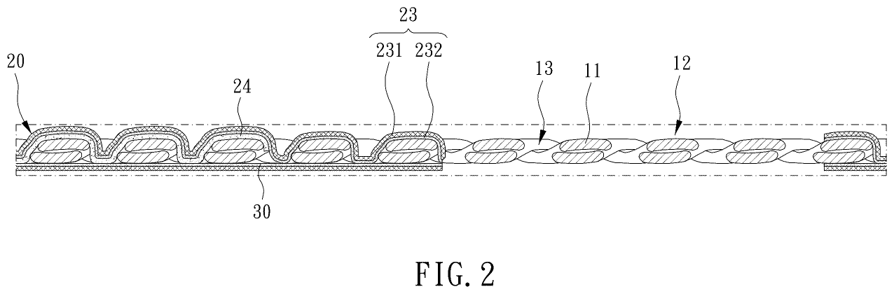

Please refer to FIGS. 1 to 2 for a preferable embodiment of the present invention. A textile fabric 1 of the present invention includes a main body 10, a first covering layer 20 and a second covering layer 30.

The main body 10 is made of a plurality of yarns 11 interlaced with one another and includes two surfaces 12 opposite to each other and a plurality of through holes 13 extending through the two surfaces 12, and the plurality of yarns 11 include at least one elastic yarn. The first covering layer 20 is coveringly disposed on one of the two surfaces 12 and includes at least one first region 21 and at least one second region 22, and a thickness of each said second region 22 is different from a thickness of one said first region 21. The second covering layer 30 is coveringly disposed on the other of the two surfaces 12 and connected with the first covering layer 20 via the plurality of through holes 13. Therefore, the first covering layer 20 and the second covering layer 30 are partially or completely covered on the main body 10 to increase a tensile strength of the main body 10.

In this embodiment, the at least one elastic yarn is made of a material including at least one of spandex and rubber, and each of the plurality of yarns 11 may include at least one of said elastic yarn or be interlaced with the at least one elastic yarn so that the main body 10 is elastically stretchable. Specifically, the plurality of yarns 11 are interlaced with one another to form the plurality of through holes 13. The first covering layer 20 is partially covered on one of the two surfaces 12 and adhered to a portion of the plurality of yarns 11 so that an interval between at least two of the plurality of yarns 11 is restricted by the first covering layer 20. A depth that the first covering layer 20 recessed within the plurality of through holes 13 is larger than a depth that the second covering layer 30 recessed within the plurality of through holes 13. Therefore, the first covering layer 20 is concave and convex corresponding to a surface texture of one of the two surfaces 12 and provides preferable appearance, and a surface of the second covering layer 30 is relative smooth to provide comfortable feeling of touching. However, the main body may be cut to form the plurality of through holes.

A distribution area of the at least one first region 21 is larger than a distribution area of the at least one second region 22. Moreover, the first covering layer 20 includes at least one first ply 23 and at least one second ply 24, and an extending area of each said second ply 24 is smaller than an extending area of each said first ply 23. The at least one second ply 24 is disposed on a side of the at least one first ply 23 to form the at least one second region 22, and a region of the main body 10 covered by the at least one first ply 23 without said second ply 24 is defined as the at least one first region 21. The at least one second ply 24 is preferably arranged between the at least one first ply 23 and the main body 10, and each of the at least one second ply 24 is completely covered by the at least one first ply 23, as shown in FIG. 2. As a results, the thickness of each said second region 22 is larger than a thickness of each said first region 21, each said second ply 24 is not easy to peel off, and each said second region 22 provides good wear-resistance effect and tensile strength. Each said second region 22 may be arranged with one or more of said second ply 24, which is adjustable to meet different thickness requirements. In other embodiments, the at least one second ply may be disposed on a side of the at least one first ply remote from the main body so as to avoid wear and tear on the at least one first ply.

Each said first ply 23 is made of a material including polyurethane, which has the advantages of wear resistance, good toughness, environment friendly and easy decomposition. In this embodiment, each said first ply 23 includes a film portion 231 and a connecting portion 232, and the connecting portion 232 is disposed on a side of the film portion 231 and connected with one of the two surfaces 12 so that each said first ply 23 can be directly connected to one of the two surfaces 12 and the second covering layer 30, which is easy to be processed and provides stable connection. The film portion 231 is preferably integrated with the connecting portion 232 in advance. For example, the connecting portion 232 may be partially or completely pre-coated, spayed or filmed on a side of the film portion 231 so that each said first ply 23 is convenient to be used during processing. A color of each said first ply 23 is different from a color of each said second ply 24. In this embodiment, each said first ply 23 is colorless and light permeable, and each said second ply 24 is colored so as to be matched with the main body 10 to generate various visual effects. In other embodiments, the color of each said first ply and the color of each said second ply may be the same; each said first ply and each said second ply may be made of the same material or different materials; thicknesses of each said first ply and each said second ply may be the same with or different from each other.

At least ½ of a distribution area of the second covering layer 30 on one of the two surfaces 12 of the main body 10 is coincided with a distribution area of the first covering layer 20 on the other of the two surfaces 12 in a thickness direction. Each said first ply 23 and the second covering layer 30 are made of the same material and are stably connected with each other by said connecting portion 232, no adhesives is required, which is easy to be processed and low cost. In other embodiments, the second covering layer may be made of other materials, such as non-woven fabrics, cotton fabrics, etc., so as to be comfortable to use.

In this embodiment, the textile fabric 1 is used as a vamp of a shoe, the at least one first region 21 is arranged along an edge of the vamp to increase tensile strength, and the at least one second region 22 is arranged to a front side of the vamp to provide wear-resistance effect. Specifically, areas of the vamp without the first covering layer 20 and the second covering layer 30 retain the original elasticity of the main body 10, and a portion of the vamp with eyelets arranged thereto is covered by the first covering layer 20, which prevents the plurality of yarns 11 from falling apart on edges of the eyelets and provides sufficient tensile strength to avoid deformation. However, the textile fabric may be applicable to abdominal binders, braces, shoes, or the like, which has a wide range of application.

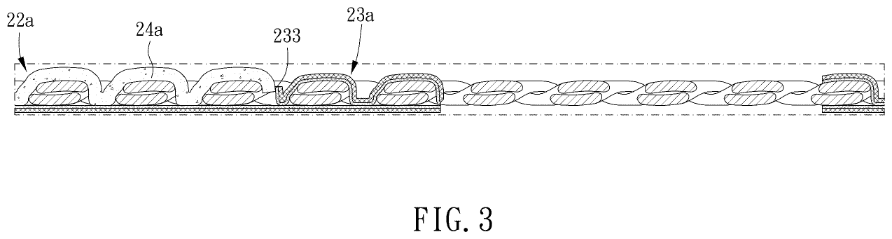

Please refer to another preferable embodiment of the present invention as shown in FIG. 3, which is different from the embodiment as described above in that: the at least one first ply 23a has at least one penetrating hole 233 disposed therethrough, and at least a portion of each said second ply 24a is located within one said penetrating hole 233 to form the at least one second region 22a. The thickness of each said second ply 24a is larger than the thickness of each said first ply 23a. Therefore, said penetrating holes 233 are arranged on the at least one first ply 23a according to design requirements, and said second plies 24a are provided according to thickness requirements of different positions. Each said second ply 24 is made of a material with an abrasion resistance (or a tensile strength) greater than that of a material of each said first ply 23 so as to locally increase a tensile strength of the main body 10.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A textile fabric, including:
a main body, made of a plurality of yarns interlaced with one another, including two surfaces opposite to each other and a plurality of through holes extending through the two surfaces, the plurality of yarns including at least one elastic yarn;
a first covering layer, coveringly disposed on one of the two surfaces, including at least one first region and at least one second region, a thickness of each said second region being different from a thickness of one said first region; and
a second covering layer, coveringly disposed on the other of the two surfaces and connected with the first covering layer via the plurality of through holes.

2. The textile fabric of claim 1, wherein the at least one elastic yarn is made of a material including at least one of spandex and rubber.

3. The textile fabric of claim 1, wherein a distribution area of the at least one first region is larger than a distribution area of the at least one second region, and a thickness of each said second region is larger than a thickness of each said first region.

4. The textile fabric of claim 1, wherein the first covering layer includes at least one first ply and at least one second ply, an extending area of each said second ply is smaller than an extending area of each said first ply, and the at least one second ply is disposed on a side of the at least one first ply to form the at least one second region.

5. The textile fabric of claim 4, wherein the at least one second ply is arranged between the at least one first ply and the main body.

6. The textile fabric of claim 1, wherein the first covering layer includes at least one first ply and at least one second ply, the at least one first ply has at least one penetrating hole disposed therethrough, and at least a portion of each said second ply is located within one said penetrating hole to form the at least one second region.

7. The textile fabric of claim 6, wherein a thickness of each said second ply is larger than a thickness of each said first ply.

8. The textile fabric of claim 1, wherein at least ½ of a distribution area of the second covering layer on one of the two surfaces of the main body is coincided with a distribution area of the first covering layer on the other of the two surfaces in a thickness direction.

9. The textile fabric of claim 1, wherein the first covering layer is partially covered on one of the two surfaces and adhered to a portion of the plurality of yarns so that an interval between at least two of the plurality of yarns is restricted by the first covering layer.

10. The textile fabric of claim 5, wherein the plurality of yarns are interlaced with one another to form the plurality of through holes; the at least one elastic yarn is made of a material including at least one of spandex and rubber; a distribution area of the at least one first region is larger than a distribution area of the at least one second region, and a thickness of each said second region is larger than a thickness of each said first region; each said first ply is made of a material including polyurethane; a color of each said first ply is different from a color of each said second ply; each said first ply includes a film portion and a connecting portion, the connecting portion is disposed on a side of the film portion and connected with one of the two surfaces; at least ½ of a distribution area of the second covering layer on one of the two surfaces of the main body is coincided with a distribution area of the first covering layer on the other of the two surfaces in a thickness direction; each said first ply and the second covering layer are made of the same material; the first covering layer is partially covered on one of the two surfaces and adhered to a portion of the plurality of yarns so that an interval between at least two of the plurality of yarns is restricted by the first covering layer; and a depth that the first covering layer recessed within the plurality of through holes is larger than a depth that the second covering layer recessed within the plurality of through holes.
